(19) United States
(12) Patent Application Publication
(10) Pub. No.: US 2025/0129970 A1
(43) Pub. Date: Apr. 24, 2025

(54) WATER MIXING DEVICE AND WATER PURIFIER INCLUDING THE SAME

(71) Applicant: COWAY Co., Ltd., Gongju-si (KR)

(72) Inventors: Si Jun PARK, Seoul (KR); In Du CHOI, Seoul (KR); Jung Chul PARK, Seoul (KR)

(73) Assignee: COWAY Co., Ltd., Gongju-si (KR)

(21) Appl. No.: 18/918,281

(22) Filed: Oct. 17, 2024

(30) Foreign Application Priority Data
Oct. 24, 2023 (KR) 10-2023-0142700

(51) Int. Cl. F24H 15/223; C02F 1/00; F24H 15/215; F24H 15/219

(52) U.S. Cl. CPC F24H 15/223; C02F 1/001; F24H 15/215; F24H 15/219

(57) ABSTRACT

A water mixing device into which water flows, the device comprises: a cold water module including a cold water body into which all water flowing in the water mixing device is introduced, a cooler for cooling the water introduced into the cold water body to cold water, and a cold water temperature sensor for detecting a temperature of the cold water; a hot water module including a hot water body into which cold water discharged from the cold water body is introduced, a heater for heating the cold water introduced into the hot water body to hot water, and a hot water temperature sensor for detecting a temperature of the hot water.

### TECHNICAL FIELD

The present disclosure relates to a water mixing device and a water purifier including the same.

### BACKGROUND

In general, a water purifier is a device that receives water from a water supply source such as a tap, filters it into purified water through a filter provided therein, and then provides the purified water to a user. Such a water purifier can provide to the user not only purified water, but also hot water, cold water, and lukewarm water which is a mixture of hot and cold water to a user. The water purifier may include a cold water storage tank, a hot water storage tank, and a lukewarm water extraction device that mixes cold water discharged from the cold water storage tank and hot water discharged from the hot water storage tank to form lukewarm water.

However, conventional water purifiers have a problem in that the temperature of lukewarm water cannot be maintained consistently each time lukewarm water is provided. In other words, conventional water purifiers have a problem in that users cannot receive lukewarm water at their desired temperature due to large temperature variations in the lukewarm water dispensed. In particular, in the case of cooking that is sensitive to water temperature, such as baking, large temperature variations in lukewarm water may affect the taste and flavor of food.

In this regard, Korean Patent Application Publication No. 10-2009-0126857 entitled “Lukewarm water extraction device and water purifier including the same” (Patent Document 1) of the subject applicant, discloses a water purifier including a hot water cock body that discharges hot water, and a lukewarm water regulating device that provides cold water to hot water discharged from the hot water cock body to form lukewarm water.

However, the lukewarm water extraction device of the water purifier of Patent Document 1 has a problem in that since the temperature of the hot water and the temperature of the cold water are not considered when mixing hot water and cold water to provide lukewarm water, temperature variations in the lukewarm water occurs depending on the temperature of the hot water and the temperature of the cold water. In other words, in the water purifier of Patent Document 1, the temperature of lukewarm water may deviate from the target temperature range.

In addition, Korean Patent Publication No. 10-2020-0111366 entitled “Water purifier” (Patent Document 2) of Cuckoo Homesys Co., Ltd. discloses a water purifier including a hot water valve for discharging hot water from a hot water tank and a cold water valve for discharging cold water from a cold water tank to form lukewarm water.

However, the water purifier of Patent Document 2 has a problem in that the mixing ratio of hot and cold water cannot be accurately controlled because an error in the opening and closing time may occur when the cold water valve and the hot water valve are repeatedly opened and closed initially to form lukewarm water. In addition, the valve control error may increase further as the valve ages due to the increased stress caused by the repeated opening and closing of the valve multiple times, which increases the error in the mixing ratio. In other words, even if the cold water valve and the hot water valve are repeatedly opened and closed alternately as in Patent Document 2, the problem in that the mixing ratio for lukewarm water cannot be maintained still exists. In addition, if either the cold water or the hot water is discharged first as in the water purifier of Patent Document 2, other secondary problems may occur. For example, when cold water is dispensed first and then hot water is dispensed, the cold and hot water may not mix evenly in a cup, and the temperature of the water at the top of the cup may be significantly higher than the temperature of the water at the bottom of the cup. Further, when hot water is dispensed first and then cold water is dispensed, the hot water previously contained in the cup may splash out of the cup, which may cause a risk of scalding the user.

### PRIOR ART DOCUMENT

### Patent Document

Patent Document 1: Korean Patent Application Publication No. 10-2009-0126857 (published on Dec. 9, 2009)
Patent Document 2: Korean Patent Application Publication No. 10-2020-0111366 (published on Sep. 29, 2020)

### SUMMARY

In view of the above, the present disclosure provides a water purifier capable of maintaining the temperature of lukewarm water at a constant level each time lukewarm water is dispensed from the water purifier.

Further, the present disclosure provides lukewarm water at room temperature (e.g., lukewarm water in a temperature range of 26° C. to 29° C.) which is a narrower temperature range than the typical lukewarm water temperature range of 15° C. to 60° C.

In accordance with one embodiment of the present disclosure, a water mixing device into which water flows, the device comprises: a cold water module including a cold water body into which all water flowing in the water mixing device is introduced, a cooler for cooling the water introduced into the cold water body to cold water, and a cold water temperature sensor for detecting a temperature of the cold water; a hot water module including a hot water body into which cold water discharged from the cold water body is introduced, a heater for heating the cold water introduced into the hot water body to hot water, and a hot water temperature sensor for detecting a temperature of the hot water; a flow channel connected to the cold water body and the hot water body to provide a passage through which cold water and hot water flow, and to provide a passage through which lukewarm water mixed with cold water and hot water flows; a valve unit including one or more valve modules that open and close to control flow of water in the flow channel; and a controller for controlling the one or more valve modules, wherein the valve unit includes: a cold water valve module that opens and closes to allow cold water in the cold water body to flow in the flow channel; and a hot water valve module that opens and closes to allow hot water in the hot water body flows in the flow channel, and wherein the controller opens the cold water valve module for a preset cold water opening time based on the temperature of the cold water detected by the cold water temperature sensor, and opens the hot water valve module for a preset hot water opening time based on the temperature of the hot water detected by the hot water temperature sensor, to ensure the lukewarm water reaches a preset target temperature while simultaneously opening the cold water valve module and the hot water valve module, and wherein the cold water opening time is longer than the hot water opening time.

Further, the target temperature may be 26° C. to 29° C.

Further, a correspondence relationship between a plurality of cold water temperature data, a plurality of hot water temperature data, and a plurality of hot water setting time data may be input in advance in the controller, and wherein when the cold water temperature detected by the cold water temperature sensor corresponds to any one of the plurality of cold water temperature data, and the hot water temperature detected by the hot water temperature sensor corresponds to any one of the plurality of hot water temperature data, the controller selects any one of the plurality of hot water setting time data based on the input correspondence relationship and sets the selected hot water setting time data as the hot water opening time.

Further, the plurality of hot water setting time data may be set to decrease as the hot water temperature increases.

Further, a plurality of cold water setting time data corresponding to the plurality of cold water temperature data and the plurality of hot water temperature data may be further input in advance in the controller, and wherein when the cold water temperature detected by the cold water temperature sensor corresponds to any one of the plurality of cold water temperature data, and the hot water temperature detected by the hot water temperature sensor corresponds to any one of the plurality of hot water temperature data, the controller selects any one of the plurality of cold water setting time data based on the inputted correspondence relationship and sets the selected cold water setting time data as the cold water opening time.

Further, the plurality of cold water setting time data may be set with a same value.

Further, the plurality of cold water temperature data may include: a first cold water temperature data of 5° C. to 15° C.; and a second cold water temperature data of 16° C. to 20° C.

Further, the plurality of cold water temperature data may include: a first hot water temperature data of 97° C. to 100° C.; a second hot water temperature data of 95° C. to 96° C.; a third hot water temperature data of 90° C. to 94° C.; and a fourth hot water temperature data of 80° C. to 89° C.

Further, a water purifier may comprise: the water mixing device and a filter unit that filters raw water to provide purified water to the water mixing device.

According one embodiment of the present disclosure, the cold water opening time and the hot water opening time can be set based on the temperature of the hot water and the temperature of the cold water, so that lukewarm water can be provided while the temperature of the lukewarm water is consistently maintained at a preset target temperature.

In addition, according to one embodiment of the present disclosure, it is possible to provide lukewarm water at room temperature (e.g., in a range of 26° C. to 29° C.), which is a narrower temperature range than the typical lukewarm water temperature range of 15° C. to 60° C.

In addition, according to one embodiment of the present disclosure, the cold water valve module and the hot water valve module can be opened at the same time, which prevents either the temperature of the hot water or the temperature of the cold water from changing before the hot water and the cold water are mixed.

### BRIEF DESCRIPTION OF THE DRAWINGS

FIG. 1 is a diagram illustrating the discharge of lukewarm water from a cold water body of a water purifier according to one embodiment of the present disclosure.

FIG. 2 is a diagram illustrating water flowing into the cold water body of the water purifier of FIG. 1.

### DETAILED DESCRIPTION

Hereinafter, specific embodiments for implementing the technical ideas of the present disclosure will be described in detail with reference to the drawings.

In addition, in describing the present disclosure, when it is determined that a detailed description of the relevant known configuration or function may obscure the gist of the present disclosure, the detailed description will be omitted.

Further, when a component is described as being “connected” or “flowing” to another component, it should be understood that it may be directly connected or flowing to another component, but there may be other components in between.

The terms used in the present specification are used merely to describe the specific embodiments and are not intended to limit the present disclosure. Singular expressions include the plural unless the context clearly indicates otherwise.

In addition, it should be noted in advance that in the present specification, expressions such as upper, lower, side, etc. are described based on the illustrations in the drawings, and may be expressed differently if the orientation of the subject is changed. For the same reason, in the accompanying drawings, some components are exaggerated, omitted, or schematically shown, and the size of each component does not entirely reflect the actual size.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

Hereinafter, the specific configuration of a water purifier according to one embodiment of the present disclosure will be described with reference to the drawings.

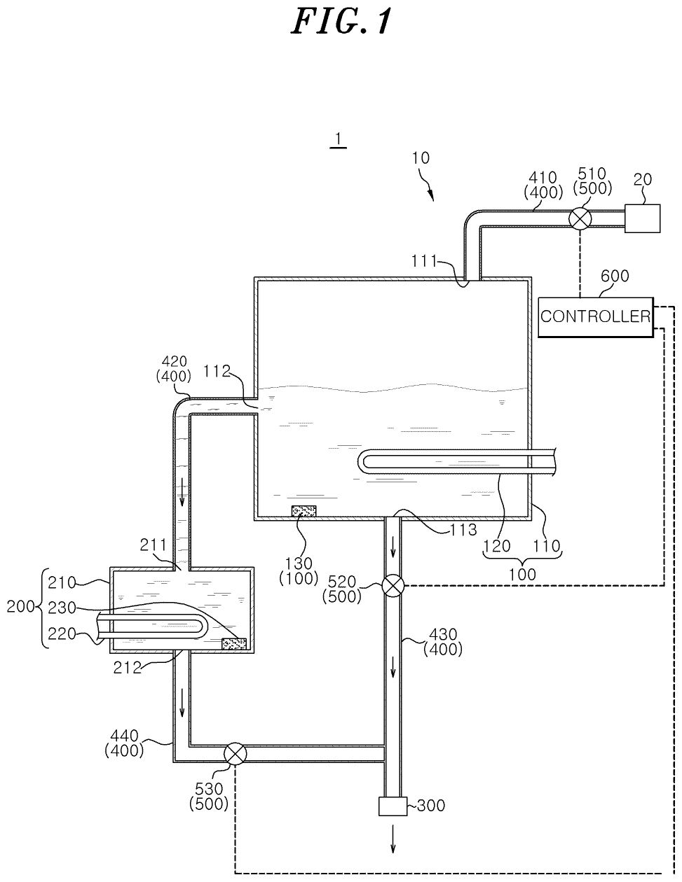

Referring to FIG. 1, a water purifier 1 according to one embodiment of the present disclosure can provide clean water to a user by filtering water supplied from an external source. For example, the water purifier 1 can receive water from a water supply source (not shown) such as a tap, and can filter the supplied water into purified water. The water purifier 1 may include a water mixing device 10 and a filter unit 20.

The water mixing device 10 can mix cold water and hot water. Cold water means water at a preset temperature or below, and hot water means water at a temperature above the preset temperature. The water mixing device 10 can provide lukewarm water that is a mixture of cold water and hot water. For example, lukewarm water may be water at a temperature of 26° C. to 29° C. In addition, water filtered by the filter unit 20 may be introduced into the water mixing device 10. In other words, purified water may be introduced into the water mixing device 10. The water mixing device 10 may include a cold water module 100, a hot water module 200, a dispense unit 300, a flow channel 400, a valve unit 500, and a controller 600.

The cold water module 100 can cool water to a preset temperature or below. In other words, the cold water module 100 can produce cold water. The cold water module 100 may include a cold water body 110, a cooler 120, and a cold water temperature sensor

All water that flows into the water mixing device 10 may flow into the cold water body 110. In addition, the cold water body 110 may be disposed above the hot water module 200 and configured to discharge cold water to a hot water body 210, which will be described later, of the hot water module 200 when hot water is discharged from the hot water body 210. Further, the cold water body 110 may be formed with a water inlet port 111, a cold water supply port 112, and a cold water discharge port 113.

The water inlet port 111 is an opening that connects the interior of the cold water body 110 and a water inflow path 410, which will be described later, of the flow channel 400. Water flowing in the water inflow path 410 can be introduced into the cold water body 110 through the water inlet port 111. For example, the water inlet port 111 may be formed at an upper side of the cold water body 110.

The cold water supply port 112 is an opening that connects the interior of the cold water body 110 and a cold water supply path 420, which will be described later, of the flow channel 400. The cold water contained in the cold water body 110 can be discharged into the cold water supply path 420 through the cold water supply port 112. In addition, the cold water supply port 112 may be positioned below the water inlet port 111.

The cold water discharge port 113 is an opening that connects the interior of the cold water body 110 and a cold water discharge path 430, which will be described later, of the flow channel 400. The cold water contained in the cold water body 110 can be discharged to the cold water discharge path 430 through the cold water discharge port 113.

The cooler 120 may supported on the cold water body 110 to cool the water in the cold water body 110. The cooler 120 may include a thermoelectric element, an evaporative refrigerant pipe, etc.

The cold water temperature sensor 130 can detect the temperature of the water in the cold water body 110. The cold water temperature sensor 130 may be disposed closer to either the cold water supply port 112 or the cold water discharge port 113 than to the water inlet port 111. For example, the cold water temperature sensor 130 may be provided on a bottom surface of the cold water body 110 and disposed closer to the cold water discharge port 113 than to the water inlet port 111 and the cold water supply port 112. By the cold water temperature sensor 130, the temperature of cold water discharged from the cold water body 110 can be accurately measured.

The hot water module 200 may heat the water introduced into it so that the temperature of the water exceeds the preset temperature. In addition, the hot water module 200 may receive cold water discharged from the cold water module 100. In other words, the hot water module 200 can heat cold water to hot water. The hot water module 200 may include a hot water body 210, a heater 220, and a hot water temperature sensor 230.

The hot water body 210 may receive water discharged from the cold water body 110. The hot water body 210 may be disposed below the cold water body 110. The hot water body 210 may be filled with cold water so that no air is contained therein. In other words, water may be continuously filled in the hot water body 210 up to the cold water body 110. A connection port 211 and a hot water outlet 212 may be formed in the hot water body 210.

The connection port 211 is an opening that connects the interior of the hot water body 210 and the cold water supply path 420 of the flow channel 400. Water flowing in the cold water supply path 420 can flow into the hot water body 210 through the connection port 211.

The hot water discharge port 212 is an opening that connects the interior of the hot water body 210 and a hot water discharge path 440, which will be described later, of the flow channel 400. The hot water in the hot water body 210) can be discharged into the hot water discharge path 440 through the hot water discharge port 212.

The heater 220 may be supported on the hot water body 210 to heat the water contained in the hot water body 210. By the heater 220, cold water in the hot water body 210 can be heated to hot water.

The hot water temperature sensor 230 can detect the temperature of the hot water in the hot water body 210. In addition, the hot water temperature sensor 230 may be disposed near the hot water discharge port 212 to accurately measure the temperature of the hot water discharged through the hot water discharge port 212. For example, the hot water temperature sensor 230 may be placed on a bottom surface of the hot water body 210.

The dispense unit 300 can dispense one or more of the cold water and hot water flowing in the flow channel 400 to the outside to provide them to a user. In other words, the dispense unit 300 can dispense lukewarm water that is a mixture of cold water and hot water. The dispense unit 300 may be connected to a cold water discharge path 430, which will be described later, of the flow channel 400, but the present disclosure is not limited thereto.

The flow channel 400 may provide a passage through which water flows between the cold water body 110, the hot water body 210, and the dispense unit 300. In addition, cold water cooled by the cooler 120 and hot water heated by the heater 220 may be mixed in the flow channel 400. In other words, lukewarm water that is a mixture of cold water and hot water can be provided through the flow channel 400. The flow channel 400 may include a water inflow path 410, a cold water supply path 420, a cold water discharge path 430, and a hot water discharge path 440.

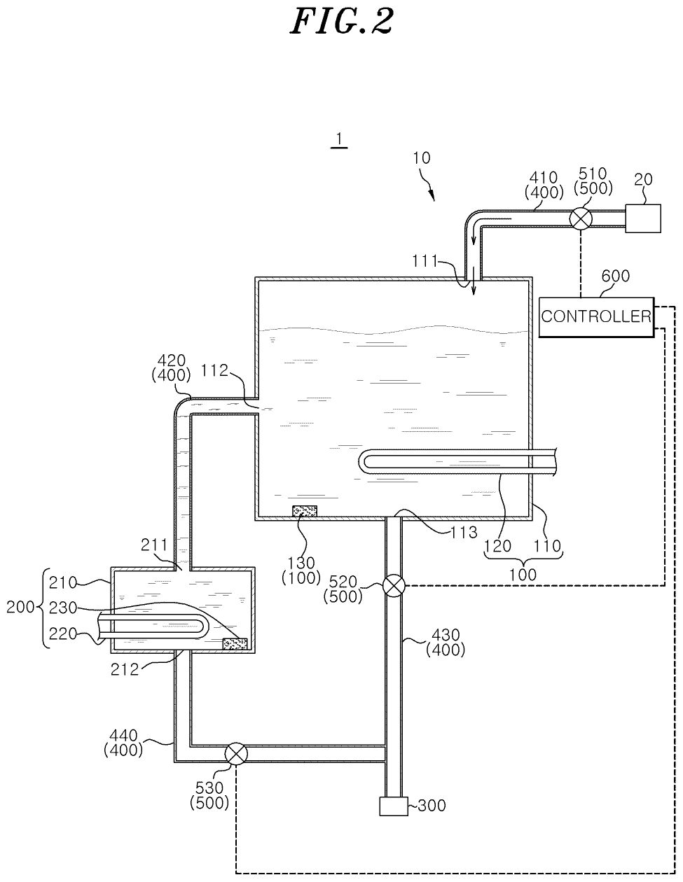

Referring further to FIG. 2, the water inflow path 410 may be connected to the cold water body 110 to provide a passage for water to flow into the cold water body 110. Purified water can flow into the cold water body 110 through the water inflow path 410.

The cold water supply path 420 may be connected to the cold water body 110 and the hot water body 210 to provide a passage for cold water discharged from the cold water body 110 to flow into the hot water body 210. The cold water can flow into the hot water body 210 through the cold water supply path 420.

The cold water discharge path 430 may be connected to the cold water body 110 to provide a passage for cold water discharged from the cold water body 110 to flow to the dispense unit 300. The cold water can flow to the dispense unit 300 through the cold water discharge path 430.

The hot water discharge path 440 may be connected to the hot water body 210 to provide a passage for hot water discharged from the hot water body 210 to flow to the dispense unit 300. The hot water can flow to the dispense unit 300 through the hot water discharge path 440.

In addition, the cold water discharge path 430 and the hot water discharge path 440 may be connected to each other so that the hot water and cold water can mix and flow to the dispense unit 300. In other words, lukewarm water, a mixture of hot water and cold water, may be provided at the point where the cold water discharge path 430 and the hot water discharge path 440 are connected. For example, one side of the hot water discharge path 440 may be connected to the hot water body 210, and the other side opposite to the one side may be connected to the cold water discharge path 430.

The valve unit 500 may include one or more valve modules that open and close to control the flow of purified water in the flow channel 400. The one or more valve modules may include an inlet valve module 510, a cold water valve module 520, and a hot water valve module 530.

The inlet valve module 510 may selectively open and close the water inflow path 410 so that water can flow into the cold water body 110. In other words, when the water inflow path 410 is opened by the inlet valve module 510, water can flow into the cold water body 110.

The cold water valve module 520 may selectively open and close the cold water discharge path 430 so that cold water can be discharged from the cold water body 110. In other words, when the cold water discharge path 430 is opened by the cold water valve module 520, cold water in the cold water body 110 can flow through the cold water discharge path 430 to the dispense unit 300. In addition, the cold water valve module 520 can control the amount of cold water discharged from the cold water body 110 to form lukewarm water. For example, the cold water valve module 520 may adjust an opening ratio of the cold water discharge path 430 to the fully opened cold water discharge path 430 to control the amount of cold water.

The hot water valve module 530 may selectively open and close the hot water discharge path 440 so that hot water can be discharged from the hot water body 210. In other words, when the hot water discharge path 440 is opened by the hot water valve module 530, hot water in the hot water body 210 can flow through the hot water discharge path 440 to the dispense unit 300. In addition, the hot water valve module 530 can control the amount of hot water discharged from the hot water body 210 to form lukewarm water. For example, the hot water valve module 530 may adjust an opening ratio of the hot water discharge path 440 to the fully opened hot water discharge path 440 to control the amount of hot water.

When the cold water valve module 520 and the hot water valve module 530 are opened simultaneously, hot water and cold water can be mixed at the point where the cold water discharge path 430 and the hot water discharge path 440 are joined.

The controller 600 may control the cold water module 100, the hot water module 200, and one or more valve modules so that lukewarm water is dispensed from the dispense unit 300. The controller 600 may open the cold water valve module 520 for a preset cold water opening time based on a temperature of the cold water detected by the cold water temperature sensor 130 to ensure that the lukewarm water reaches a preset target temperature. The target temperature may be 26° C. to 29° C. The controller 600 may close the cold water valve module 520 if the time for which the cold water valve module 520 is opened exceeds the cold water opening time.

In addition, the controller 600 may open the hot water valve module 530 for a preset hot water opening time based on a temperature of the hot water detected by the hot water temperature sensor 230 to ensure that the lukewarm water reaches the preset target temperature, while simultaneously opening the cold water valve module 520 and the hot water valve module 530. The controller 600 may close the hot water valve module 530 if the time for which the hot water valve module 530 is opened exceeds the hot water opening time. The cold water opening time may be set to be longer than the hot water opening time.

In the controller 600, a correspondence relationship between a plurality of cold water temperature data, a plurality of hot water temperature data, and a plurality of hot water setting time data may be input in advance. In addition, a plurality of cold water setting time data corresponding to the plurality of cold water temperature data and the plurality of hot water temperature data may be input in advance in the controller 600.

When the cold water temperature detected by the cold water temperature sensor 130 corresponds to any one of the plurality of cold water temperature data, and the hot water temperature detected by the hot water temperature sensor 230 corresponds to any one of the plurality of hot water temperature data, the controller 600 may select any one of the plurality of hot water setting time data based on the input correspondence relationship. In addition, the controller 600 may set the selected hot water setting time data as the hot water opening time.

When the cold water temperature detected by the cold water temperature sensor 130 corresponds to one of the plurality of cold water temperature data, and when the hot water temperature detected by the hot water temperature sensor 230 corresponds to one of the plurality of hot water temperature data, the controller 600 can select one of the plurality of cold water setting time data based on the inputted correspondence relationship. In addition, the controller 600 may set the selected cold water setting time data as the cold water opening time.

Table 1 below shows the correspondence between the plurality of cold water temperature data, the plurality of hot water temperature data, the plurality of hot water setting time data, and the plurality of cold water setting time data pre-inputted into the controller 600.

TABLE 1

| Cold water | Hot water | Cold water | Hot water |
|---|---|---|---|
| temperature | temperature | setting time | setting time |
| 5° C. to 15° C. | 97º C. to 100° C. | 5.4 sec | 4.0 sec |
| | 95° C. to 96° C. | 5.4 sec | 4.4 sec |
| | 90° C. to 94° C. | 5.4 sec | 4.6 sec |
| | 80° C. to 89° C. | 5.4 sec | 5.4 sec |
| 16° C. to 20° C. | 97° C. to 100° C. | 5.4 sec | 4.1 sec |
| | 95° C. to 96° C. | 5.4 sec | 4.2 sec |
| | 90° C. to 94° C. | 5.4 sec | 4.3 sec |
| | 80° C. to 89° C. | 5.4 sec | 5.0 sec |

Referring to Table 1, the plurality of cold water temperature data may include, but are not limited to, a first cold water temperature data of 5° C. to 15° C. and a second cold water temperature data of 16° C. to 20° C. In addition, the plurality of hot water temperature data may include, but are not limited to, a first hot water temperature data of 97° C. to 100° C., a second hot water temperature data of 95° C. to 96° C., a third hot water temperature data of 90° C. to 94° C., and a fourth hot water temperature data of 80° C. to 89° C.

In addition, in the correspondence relationship pre-inputted to the controller 600, the plurality of hot water setting time data may be input so that they decrease as the hot water temperature increases. The plurality of cold water setting time data may be input with the same value. In addition, the hot water setting time data may be less than or equal to the cold water setting time data. In other words, the cold water opening time may be greater than or equal to the hot water opening time. The higher the temperature of the hot water detected by the hot water temperature sensor 230, the shorter the hot water opening time may be than the cold water opening time.

As an example, when the temperature of cold water detected by the cold water temperature sensor 130 is 10° C. and the temperature of hot water detected by the hot water temperature sensor 230 is 97° C., the controller 600 may set the hot water opening time to 4.0 seconds and the cold water opening time to 5.4 seconds to form lukewarm water. As another example, when the temperature of cold water detected by the cold water temperature sensor 130 is 17° C. and the temperature of hot water detected by the hot water temperature sensor 230 is 91° C., the controller 600 may set the hot water opening time to 4.3 seconds and the cold water opening time to 5.4 seconds to form lukewarm water.

The controller 600 described above may be implemented by a computing device including a microprocessor, a measuring device such as a sensor, and a memory, and the implementation method is obvious to those skilled in the art, so further detailed description is omitted.

The filter unit 20 can filter the raw water introduced in the water purifier 1 into purified water. The filter unit 20 may be provided in the water inflow path 410. In other words, all water introduced into the water mixing device 10 may be purified water.

Hereinafter, the operation and effect of the water purifier 1 according to one embodiment of the present disclosure will be described. The water purifier 1 according to one embodiment of the present disclosure can set the cold water opening time and the hot water opening time based on the temperature of hot water and the temperature of cold water, so that lukewarm water can be provided while the temperature of the lukewarm water is consistently maintained at a preset target temperature.

In addition, since the cold water valve module 520 and the hot water valve module 530 can be initially opened simultaneously, either the temperature of the hot water or the temperature of the cold water can be prevented from changing before the hot water and cold water are mixed. Further, by setting the cold water opening time to be longer than the hot water opening time, lukewarm water at room temperature as requested by the user can be provided.

In addition, there is the advantage of being able to provide lukewarm water at room temperature (e.g., in the range of 26° C. to 29° C.), which is a narrower temperature range than the typical lukewarm water temperature range of 15° C. to 60° C.

Although the embodiments of the present disclosure have been described as specific embodiments, these are merely examples, and the present disclosure should be interpreted to have the broadest scope according to the technical idea disclosed in the present specification without being limited thereto. Those skilled in the art may combine/substitute the disclosed embodiments to implement a pattern of a shape not specified, but this also does not go beyond the scope of the present disclosure. In addition, those skilled in the art may easily change or modify the disclosed embodiments based on the present specification, and it is clear that such changes or modifications also fall within the scope of the present disclosure.

1. A water mixing device into which water flows, the device comprising:
a cold water module including a cold water body into which all water flowing in the water mixing device is introduced, a cooler for cooling the water introduced into the cold water body to cold water, and a cold water temperature sensor for detecting a temperature of the cold water;
a hot water module including a hot water body into which cold water discharged from the cold water body is introduced, a heater for heating the cold water introduced into the hot water body to hot water, and a hot water temperature sensor for detecting a temperature of the hot water;
a flow channel connected to the cold water body and the hot water body to provide a passage through which cold water and hot water flow, and to provide a passage through which lukewarm water mixed with cold water and hot water flows;
a valve unit including one or more valve modules that open and close to control flow of water in the flow channel; and
a controller for controlling the one or more valve modules,
wherein the valve unit includes:
a cold water valve module that opens and closes to allow cold water in the cold water body to flow in the flow channel; and
a hot water valve module that opens and closes to allow hot water in the hot water body flows in the flow channel, and
wherein the controller opens the cold water valve module for a preset cold water opening time based on the temperature of the cold water detected by the cold water temperature sensor, and opens the hot water valve module for a preset hot water opening time based on the temperature of the hot water detected by the hot water temperature sensor, to ensure the lukewarm water reaches a preset target temperature while simultaneously opening the cold water valve module and the hot water valve module, and
wherein the cold water opening time is longer than the hot water opening time.

2. The water mixing device of claim 1, wherein the target temperature is 26° C. to 29° C.

3. The water mixing device of claim 1, wherein a correspondence relationship between a plurality of cold water temperature data, a plurality of hot water temperature data, and a plurality of hot water setting time data is input in advance in the controller, and
wherein when the cold water temperature detected by the cold water temperature sensor corresponds to any one of the plurality of cold water temperature data, and the hot water temperature detected by the hot water temperature sensor corresponds to any one of the plurality of hot water temperature data, the controller selects any one of the plurality of hot water setting time data based on the input correspondence relationship and sets the selected hot water setting time data as the hot water opening time.

4. The water mixing device of claim 3, wherein the plurality of hot water setting time data are set to decrease as the hot water temperature increases.

5. The water mixing device of claim 3, wherein a plurality of cold water setting time data corresponding to the plurality of cold water temperature data and the plurality of hot water temperature data is further input in advance in the controller, and
wherein when the cold water temperature detected by the cold water temperature sensor corresponds to any one of the plurality of cold water temperature data, and the hot water temperature detected by the hot water temperature sensor corresponds to any one of the plurality of hot water temperature data, the controller selects any one of the plurality of cold water setting time data based on the inputted correspondence relationship and sets the selected cold water setting time data as the cold water opening time.

6. The water mixing device of claim 5, wherein the plurality of cold water setting time data are set with a same value.

7. The water mixing device of claim 3, wherein the plurality of cold water temperature data includes:
a first cold water temperature data of 5° C. to 15° C.; and
a second cold water temperature data of 16° C. to 20° C.

8. The water mixing device of claim 3, wherein the plurality of cold water temperature data includes:
a first hot water temperature data of 97° C. to 100° C.;
a second hot water temperature data of 95° C. to 96° C.;
a third hot water temperature data of 90° C. to 94° C.; and
a fourth hot water temperature data of 80° C. to 89° C.

9. A water purifier comprising:
the water mixing device of claim 1; and
a filter unit that filters raw water to provide purified water to the water mixing device.
